(19) United States
(12) Patent Application Publication
(10) Pub. No.: US 2005/0022686 A1
(43) Pub. Date: Feb. 3, 2005

(54) Apparatus, method, and computer program product for animation pad transfer

(75) Inventors: Philip G. Wessells, Mill Valley, CA (US); Michael Simonian, San Francisco, CA (US); Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: DreamPatch, LLC, Mill Valley, CA (US)

(21) Appl. No.: 10/728,118

(22) Filed: Dec. 3, 2003

Related U.S. Application Data
(63) Continuation-in-part of application No. 10/628,750, filed on Jul. 28, 2003, now abandoned.

(51) Int. Cl. B41M 1/00

(52) U.S. Cl. 101/368

(57) ABSTRACT

The present invention includes apparatus and method for image sequence transfer onto one of a plurality of a pad medium pages while the pages are aggregated together. A preferred embodiment for a printer includes An image transfer apparatus, including a housing; an image transfer engine for transferring a series of images at a transfer position; and a transfer medium registration system for positioning a pad including a plurality of transfer media releasably secured to one another, wherein the transfer registration system locates a series of individual ones of the transfer media at the transfer position to receive different images of the series of images. The image sequence transferring method includes positioning a pad at a transfer position of a transfer engine, the pad including a plurality of transfer media releasably secured to one another; and transferring a series of images to successive ones of the transfer media serially positioned at the transfer position

### CROSS REFERENCE TO RELATED APPLICATIONS

The present application is a CONTINUATION-IN-PART of application Ser. No. 10/628,750 entitled APPARATUS AND METHOD FOR ANIMATION PAD PRINTING filed 28 Jul. 2003, and is related to both application Ser. No. 10/628,820 entitled “APPARATUS AND METHOD FOR IMAGE CAPTURE AND PAD TRANSFER” and application Ser. No. 10/628,749 entitled “APPARATUS AND METHOD FOR PAD TRANSFER” both filed on 28 Jul. 2003; and is related to application Ser. No. 10/618,107 entitled Image Transfer System and Method, filed 10 Jul. 2003 and Application Serial Number______ (20003-7023) entitled “APPARATUS, METHOD, AND COMPUTER PROGRAM PRODUCT FOR PAD TRANSFER” and filed on even date herewith. These related applications are all hereby expressly incorporated by reference for all purposes.

### BACKGROUND OF THE INVENTION

The present invention relates generally to printing systems, and more particularly to printing systems for transferring a series of images to a pad of transfer medium.

There are many types of printing systems available today. These systems include dot-matrix, thermal printers, electrostatic image transfer, ink ejectment, and the like. These systems are adapted for printing successive images on individual sheets of separate pages drawn from a paper reserve stack. There are many different mechanisms for extracting individual sheets and directing them to the image application portion of the printer. What these printers have in common is that the printing systems are adapted for accessing, controlling, routing and printing a single sheet at time.

Pads of note paper, such as Post-It® brand sticky note pads available from 3M Corporation of Minnesota, are well known. These pads include stacks of pages releasably secured to each other with a tacky adhesive that permits an individual page to be removed from the pad and re-adhered to another surface. This feature of releasable securement to successive surfaces is a desirable trait of these products.

Currently to produce an image on a sticky note, a user either writes or otherwise applies some text or graphic element on the topmost page of the pad of sticky note. Later, the user removes the note to reposition it to the desired location. It would be advantageous to use a printing system to apply the element to the sticky note page. However, the current printing systems are incapable of printing on such a pad. 3M offers a solution for printing on a preformed matrix of single layer note pages arranged in a standard 8′×11′ format for running through a conventional printer. 3M offers a solution for printing on a preformed matrix of single layer note pages arranged in a standard 8′×11′ format for running through a conventional printer called a PRINTSCAPE™ Personalized Note Kit product. This product features a matrix of Post-it® Notes included on a sheet of six notes arranged in three rows of two columns. A sheet of notes is compatible with existing printers for designing individual note content on a PC and printing them as desired, much like label design and printing software.

This solution has disadvantages in that it requires access to, and use of, a full-size printer and associated computer system to reproduce the element on the note. Also, the user has to obtain pages of the special format, as well as special software for use in cooperation with the computer system operating the printer.

Animation books are also known. An animation book includes a series of sheets of paper bound together. Each page has some image on it, with the collection of images related to each other to provide a sense of animation when the images are displayed successively. This effect is similar to motion picture technology in projecting many frames per second of one or more sets of related images.

Currently, quality animation books, or flip-books, are available commercially. It is known for an animator to hand apply sequenced images individually to sets of pages to produce a rudimentary animation book. However, such a solution does not produce animation books of sufficient quality, and the production is often limited to the animator's artistic skills. There are systems, including personal computers and software for generating animation sequences from images. But these sequences must be viewed on the computer system or converted into video/film presentations for later viewing. There are systems for viewing animation sequences (e.g., AVI viewers or Quicktime viewers) on a personal computers. Some formats provide for a series of individual images to be rendered in sequence to appear to produce an animation, while other formats provide for a series of base images (and encoded changes to the base images) to be rendered, again imparting a sense of animation.

It is also known to provide screen capture applications on a personal computer for a user to selectively capture all or a portion of a static display, window, control or other display element. The programs typically provide for some editing and permit a user to “paste” copies of the captured image into another application. It is also known to provide screen capture programs for creating an animation sequence of events portrayed on a display of a personal computer while the application is in a record mode.

However, these solutions do not permit a user to create a tangible output representation of the animation sequence. One does not typically speak of “printing a movie” though individual frames may be printed when the base format is suitable. A user may be able to copy the sequence onto various mediums (disk, CD, file or film) and “play them back” for display, though the user requires a personal computer or other suitable hardware to generate the intangible representations.

It would be desirable to provide a simple and efficient apparatus, method, and computer program product to identify and duplicate onto an image medium one or more images, or related sequences of images in the case of animation, presented in electronic format.

### SUMMARY OF THE INVENTION

The present invention includes apparatus and method for image sequence transfer onto one of a plurality of a pad medium pages while the pages are aggregated together. A preferred embodiment for a printer includes An image transfer apparatus, including a housing; an image transfer engine for transferring a series of images at a transfer position; and a transfer medium registration system for positioning a pad including a plurality of transfer media releasably secured to one another, wherein the transfer registration system locates a series of individual ones of the transfer media at the transfer position to receive different images of the series of images. The image sequence transferring method includes positioning a pad at a transfer position of a transfer engine, the pad including a plurality of transfer media releasably secured to one another; and transferring a series of images to successive ones of the transfer media serially positioned at the transfer position.

The preferred embodiment of the present invention is provided as a stand-alone system for receiving a pad of a plurality of transfer media and for transferring a series of images to successive ones of the transfer media. Additionally, the printer may be incorporated into a portable image capturing device to directly transfer a captured image sequence onto the pad. To form the animation book, the images are transferred to successive media while each element is attached, or in some implementations, individual elements are collected in proper order and bound together. In the preferred implementation, a transfer registration system positions the series of transfer media elements at a transfer position of the transfer engine. Virtually any sequence of images may be transferred (e.g., captured sequences, related sets of still images, or image sets developed from one or more reference images (e.g., “morphing”), limited by the image transfer engine, the image source quality and pad size.

These and other novel aspects of the present invention will be apparent to those of ordinary skill in the art upon review of the drawings and the remaining portions of the specification.

### BRIEF DESCRIPTION OF THE DRAWINGS

FIG. 1 is a block perspective view a preferred embodiment of the present invention for a pad animation printing system;

FIG. 2 is a computer system that may function as a basic computer in implementing a preferred embodiment of the present invention in cooperation with the pad animation printing system shown in Figure_1;

FIG. 3 is a schematic block diagram of a preferred embodiment for an image capture/transfer system;

FIG. 4 is a screenshot illustrating a preferred embodiment of an interface indicator used in the preferred embodiment of the present invention; and

FIG. 5 is a schematic block diagram of an alternate preferred embodiment for an image capture/transfer system.

### DESCRIPTION OF THE SPECIFIC EMBODIMENTS

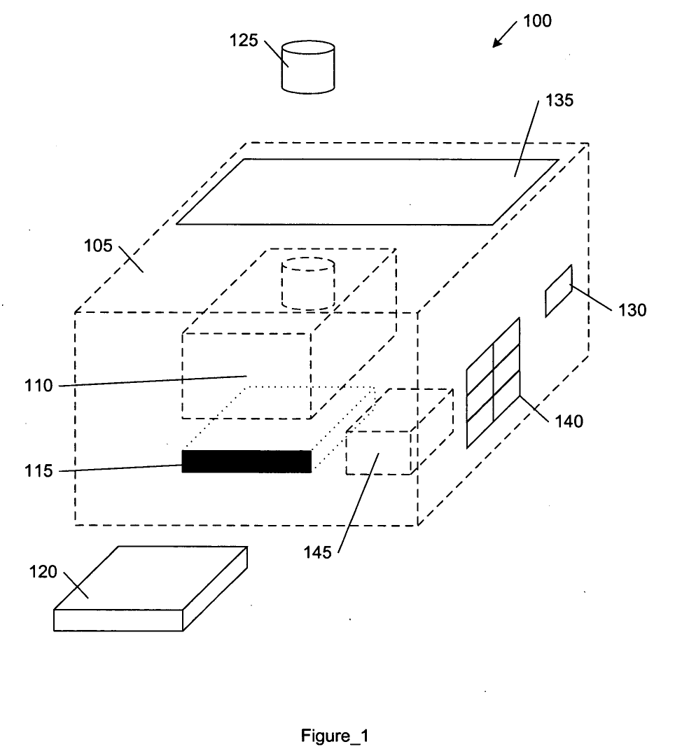

FIG. 1 is a block perspective view a preferred embodiment of the present invention for a pad transfer system 100. Transfer system 100 includes a housing 105, an image transfer engine 110, a transfer registration system 115 for receiving a pad 120.

Housing 105 contains the elements of pad transfer system 100. Housing 105 preferably also may be integrated into other devices (either physically or logically) to provide functionality such, as for example, image capture, image processing/animation generation, image storing, and/or image transmission. Pad transfer system 100 may also be enabled to work cooperatively with an image capture system, with the image capture system physically or logically integrated with pad transfer system 100.

Image transfer engine 110 is a device for applying a text or graphic element onto pad 120 when pad 120 is registered within transfer registration system 115. Image transfer engine 110 may include conventional printing systems such as, for example, a laser printer, an inkjet printer, a thermal printer, a dot-matrix printer, or the like. Image transfer engine 110 may include imaging systems like stenciling and stamping as well. Therefore image transfer engine 110 of the preferred embodiment denotes a system that imparts a perceptible image onto or into one of a transfer medium of pad 120, and the term print is used in a generic sense to include all such transfer processes.

In some implementations, image transfer engine 110 uses a printing system that consumes a print resource during the transfer process (e.g., toner in a laser printer or ink in an inkjet printer). Pad printing system 100 may provide for replaceable resource sources 125 (e.g., an ink cartridge or toner cartridge) or provide for replacement of a complete image transfer engine 110 that is new or refurbished with a fresh supply of the resource.

Pad printing system 100 includes a processing unit for controlling the functions, and includes memory for storing program instructions and, in some cases, images in a format suitable for use with image transfer engine 110. This memory may include portions that are volatile, non-volatile or some combination. In some implementations, pad printing system 100 includes one or more image access ports 130, coupled to the controller, memory, or directly to image transfer engine 110. Image access port 130 is a receiver/receptacle adapted to operatively mate with memory modules storing one or more images for application using pad printing system 100, or for coupling to another device or source of images, such as, for example, a computing system, a camera, a scanner, a video camera, or the like. Some implementations and embodiments of the present invention include rechargeable batteries to power the transfer functions. Access port 130 may be integrated into a docking station for receiving, storing, powering and otherwise interfacing to the image transfer system or to an image capture system, or both. The docking system may be used for systems lacking the rechargeable batteries.

In some implementations of the preferred embodiment, pad transfer system 100 includes a display 135 for reproducing a facsimile of an image sequence to be transferred to, or transferred by, image transfer engine 110. Display 135 also provides feedback during control or operation functions. A portion of display 135 provides feedback regarding the status of the image transfer process, such as that system 100 is ready to begin transfer, transfer is ongoing, and/or transfer has completed.

A control system 140 includes one or more buttons coupled to the controller for actuating an image transfer process, selecting an image or image sequence for transfer, accessing images through access port 130. In the preferred embodiment, control system 140 includes a “PRINT” button, the actuation of which initiates an animation transfer process.

Print registration system 115 receives pad 120 and positions a series of individual ones of transfer medium elements of the plurality of transfer media at a location to cooperate with image transfer engine 110 in the image transfer process. Pad 120 of the preferred embodiment is a stack of uniformly sized transfer medium elements (e.g., sheets of paper, though other substrates or materials are possible, including Mylar film, decals, etc.) secured to each other, preferably by edge-laminate-adhesive binding. In the preferred embodiment, pad 120 is a stack of sheets of paper bound together to permit sheets to be easily moved out from the transfer position while remaining secured to pad 120. Registration system 115 locates the current transfer medium element at the print position and holds pad 120 during the image transfer process.

In some embodiments, registration system 115 may position the bottommost transfer medium, or some other portion of pad 120. Registration system 115 may include an adapter/cartridge for holding pad 120 during image transfer. Such an adapter/cartridge is configurable to permit registration of different sized pads 120 (size differing in thickness and/or peripheral dimensions).

Registration system 115 includes a flipper 145 for separating and moving/repositioning a single transfer medium element of pad 120, either before image transfer or after. Flipper 145, depending upon its functions, may be implemented in numerous different ways. A simple implementation includes a blade or roller that slides between a sheet and the remainder of the pad to lift, separate, and move the sheet.

It is understood that pad print system 100 may also be implemented as a simple device without the display, access ports, and controls. When inserting pad 120 sufficiently far into registration system 115, image transfer begins. An LED is illuminated while the transfer process is in progress. When the LED extinguishes, pad 120 is removed with one of the pages bearing the transfer image.

In operation, a user loads pad 120 into registration system 115 that in turn locates one of the transfer medium at the desired location. A user selects a particular image sequence for transfer, either from internal memory or from an external source through image access port 130. The selected image sequence is viewed on display 135, and the user actuates the “PRINT” button to initiate the transfer system. When the transfer process is completed, pad 120, is removed from pad printing system 100. Flipping the individual elements of pad 120 simulates animation according to the image sequence.

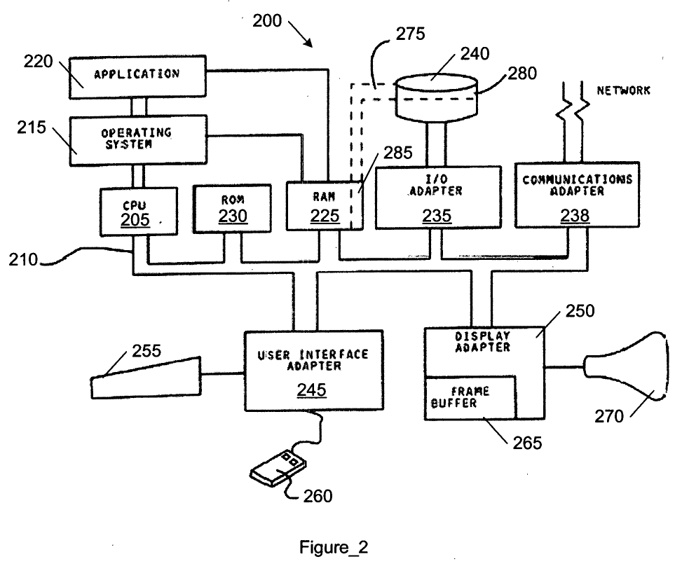

Figure_2 is a computer system 200 that may function as a basic computer in implementing the present invention for an efficient toolbar solution that provides a user with simple and quick searches across a plurality of locations, and one that may be expanded without complicated or time-consuming configuration options. Computer system 200 includes a central processing unit (CPU) 205, such as one of the PC microprocessors or workstations, e.g. RISC System/6000 (RS/6000) (RISC System/6000 is a trademark of International Business Machines Corporation) series available from International Business Machines Corporation (IBM), is provided and interconnected to various other components by a system bus 210. An operating system 215 runs on CPU 205, provides control and is used to coordinate the function of the various components of FIG. 2. Operating system 215 may be one of the commercially available operating systems such as the AIX 6000 operating system or OS/2 operating system available from IBM (AIX 6000 and OS/2 are trademarks of IBM); Microsoft's Windows 98 or Windows NT, as well as UNIX and AIX operating systems. One or more application programs 220, controlled by the system, are moved into and out of a main memory RAM 225. These programs include the program of the present invention to be subsequently described in combination with local or wide-area network systems, such as for example, the Internet. A read only memory (ROM) 230 is connected to CPU 205 via bus 210 and includes the Basic Input/Output System (BIOS) that controls the basic computer functions. RAM 225, an I/O adapter 235 and a communications adapter 238 are also interconnected to system bus 210. I/O adapter 235 may be a Small Computer System Interface (SCSI) adapter that communicates with a disk storage device 240. Communications adapter 238 interconnects bus 210 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 210 via a user interface adapter 245 and a display adapter 250. A keyboard 255 and a pointing device (e.g., mouse 260) are all interconnected to bus 210 through user interface adapter 245. It is through such input devices that the user may interactively relate to the programs for an efficient capture solution that provides a user with simple and quick captures/transfers of graphical/textual content, and one that may be expanded without complicated or time-consuming configuration options according to the present invention. Display adapter 250 includes a frame buffer 265, which is a storage device that holds a representation of each pixel on a monitor or display screen 270. Images may be stored in frame buffer 265 for display on monitor 270 through various components, such as a digital to analog converter (not shown) and the like. By using the aforementioned I/O devices, a user is capable of inputting information to the system through the keyboard 255 or mouse 260 and receiving output information from the system via display 270. The system also contains a memory cache 275 that is illustrated as a dashed line outline and includes a portion 280 of a disk storage drive 240 and a portion 285 of RAM 225.

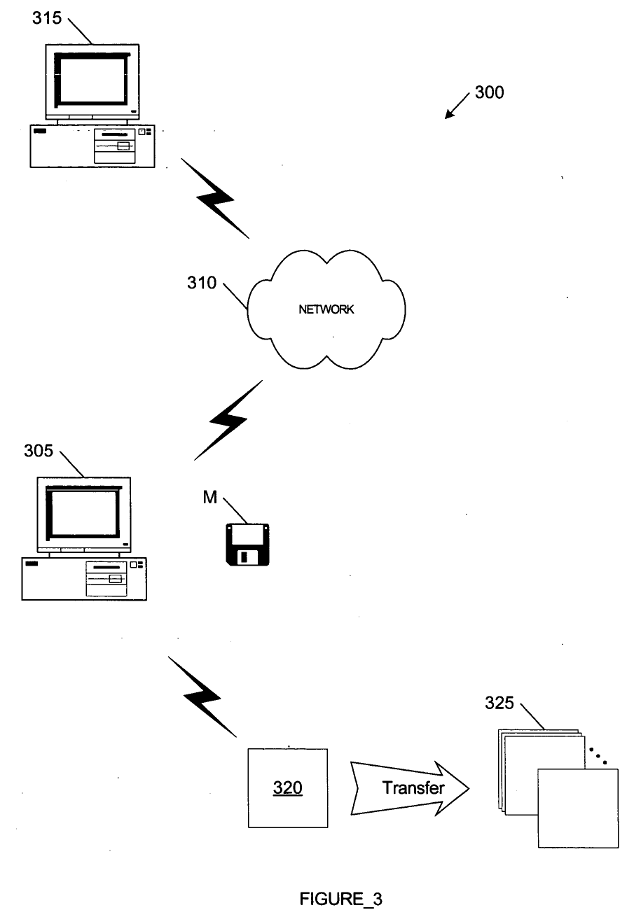

FIG. 3 is a schematic block diagram of a preferred embodiment for an image capture/transfer system 300. System 300 includes a computing system 305 coupled through a network 310 to a network computing system 315. System 300 also includes a transferer 320 for applying one or more patterns to a set of laminar media 325.

Computing system 305 and computing system 315 are each implementations of computing system 200 shown in FIG. 2. System 300 may include the computing systems in a client (e.g., 305)/server (e.g., 315) relationship, or a peer (e.g., 305) to peer (e.g., 315) relationship, among different configuration types. In some implementations, network 310 and system 315 are not used. Medium M represents any of the different types of memory/storage solutions available to the computing system for retention (e.g., short-term/long-term, volatile/non-volatile, semiconductor, magnetic, optical) of programmatic controls or data.

Network 310 includes one or more private or public network systems by which control or data information may be exchanged among coupled devices. Network 310 includes the Internet, World Wide Web (www), local area networks (LANs), Wide Area Networks (WANs), for example. Network 310 may use one or more wired or wireless communications protocols or systems, in series or parallel to exchange the control or data information. These protocols include, for example, Ethernet, Token-Ring, Bluetooth, plain old telephone system (POTS), IEEE Specifications for 802.3, 802.11a/b/g, ultra-wide band (UWB), though other protocols, existing and later developed, are applicable to the preferred embodiment.

Transferer 320 is a device for transferring one or more images, patterns, copies, replicas, counterparts, facsimiles, likenesses, matches, figures, models, stamps, engravings and the like —all hereafter referred to as images, to one or more elements of media 325. Transferer 320 may vary depending upon the nature of the laminar media as well as the type of the one or more images to be transferred, as well as the type of transfer (e.g., printing, embossing, decaling, stamping, engraving, burning, stippling, tattooing, silk-screening, applying, photostatic, xerographic, for example). Depending upon implementation, transferer 320 includes many components of computing system 200 shown in FIG. 2, often however, as a special purpose computing system with components, elements and subsystems optimized for the particular implementation.

Media 325 is, in the broadest sense, a set of laminar elements that support the transfer system and retain the desired images, and includes, for example, pad 120 shown in FIG. 1. These elements may include sheets of paper, cardboard, fabric, Mylar, foil, wax, semiconductor, photoresist, crystal, glass or other material. In the preferred embodiment, media 325 is a pad of 20-100 stacked sheets of papers bound along one edge. The binding includes a semi-tacky releasable adhesive (e.g., PostIt Notes from 3M Corporation), glued “perfect” binding, stapling, hinging, sewing, melting, molding or the like.

The preferred embodiment uses system 100, or any of the devices described in the incorporated patent applications, as transferer 300 to transfer (e.g., print) onto media 325 (when media 325 is a structured pad of co-aligned sheets of paper bound along one edge). To simplify the following discussion, a preferred embodiment will be set forth in which the transfer operation is a printing operation, media 325 is a pad of sheets of paper configured for use in cooperation with transferer 320. The pad of sheets are bound along one edge, the binding of the preferred embodiment dependent upon whether a single image is to be transferred or set of images, for example such as for an animation book. Media 325 has a length, width and thickness, the thickness based upon an individual thickness of the laminar elements and number of such elements in media 325. The length and width varies upon implementation, but generally may vary from about 1.5′×2′ and larger. Media 325 length and width will be determined partially by the capabilities of transferer 320 (e.g., an aperture size, transfer engine print area, etc.)

In operation, system 300 produces (which includes generation, location and all manner of making a desired image or set of images available to transferer 320) a desired image or set of images. The image may be available on network system 315 or system 305 (either as a static image/set of images or animation sequence), or it may be dynamically produced. In some implementations, the image/set of images may be simply communicated to transferer 320 (e.g., written into a memory or storage component). In the preferred embodiment, a target image or set of images is rendered on display 170 of system 305.

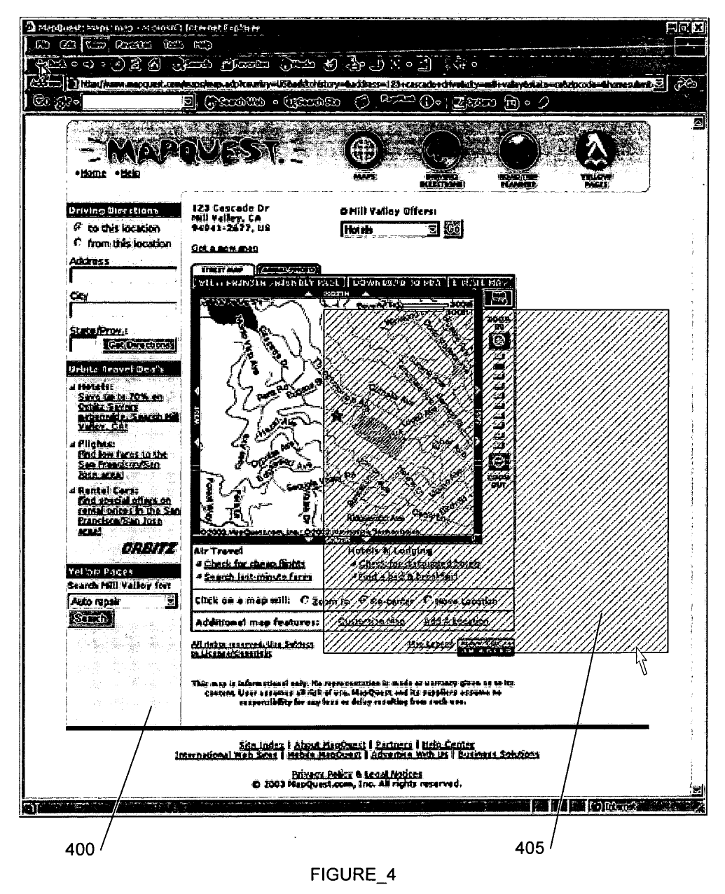

FIG. 4 is a screenshot illustrating a representative image 400 from display 170 used in the preferred embodiment of the present invention. Image 400 is a rendered image from a web browser process executing on CPU 205 of system 300 (usually system 305). As well known, a user operates I/O elements to cause the web browser process to access a resource of system 300. In FIG. 4, the resource is a map generating process of system 300 (typically the process is implemented on network system 315 and accessed by system 305 through network 310). System 300 is designed to generate an exemplar of a portion of image 400 (e.g., the detailed map section) on media 325. Many map-generating processes permit the user to obtain “driving directions” that area a detailed textual output presenting a particular course. The user may desire to produce an exemplar of the detailed textual output. Many images 400 include information that the user does not want to transfer. Additionally, in some cases, image 400 is not a static image, but a sequence of images such as from a movie, animation, or the like. There are different encoding systems for generating the sequence (e.g., on network system 315, system 305 or transferer 320).

Therefore, there will be two discussions regarding transfer of a static image, and transfer of a sequence of images, onto media 325. In either implementation, it is understood that system 300 in certain embodiments and implementations, includes an ability to perform pre-processing, processing, and/or post-processing of the target image or set of images. Preprocessing occurs to image element(s) prior to the capture by system 300, processing is of the element(s) at the time of capture, and post-processing refers to processing of the element(s) after capture and before or at the time of image transfer. Examples of processing of the preferred embodiment include control or monitoring of image scaling (e.g., size and pixel color depth). It is one feature of the preferred embodiment to simply and efficiently transfer a selected image/image set to media 325, therefore the preferred embodiment includes options to automate the capture and transfer, and consequently, the processing is preferably automated as well.

It is also part of the present invention, that one or more these processing functions may be implemented in the various components of system 300. For example, in some implementations, transferer 320 includes display 270 for rendering an image output from system 305 or system 315. The image output may be a processed/captured image or set of images or metadata concerning image properties, for example, and the user may desire to further perform local modification to the image. Transferer 320 in some implementations includes various editing tools/features to modify, enhance, or manipulate the image. For example, text may be added or image elements may be removed or enhanced through an I/O system (e.g., pen, keys) of transferer 320.

First, static image capture of the preferred embodiment will be described with respect to capture and transfer of a portion of image 400 rendered on display 270 of image 400. There are many well-known methods to implement and launch a user interface for a computing system. An interface 405 according to the preferred embodiment is shown in FIG. 4. Interface 405 is an overlying semi-transparent window. Upon actuation, interface 405 presents the window over image 400. The window has an initial size corresponding to the width and length of the laminar elements of media 325. Preferably, the correspondence is a one-to-one correspondence between the window size and the transfer region of the laminar element, though other implementations may prefer to have a different correspondence. The target image may be “zoomed” or “compressed” to fit the target size, based upon the size of the selected region. In the preferred embodiment, the semi-transparent window is tinted (e.g., yellow like a Post-it® Note), and may include a capture-related logo, either as a watermark or become incorporated into the cursor to define the capture area to cue the user as to the current operation. The logo could be the logo of the provider of interface 405, system 305, or media 325.

The window is moveable and resizable using I/O components of the appropriate computing system to match the window of interface 405 to the desired features of image 400. After positioning and sizing, the capture/transfer feature of interface 405 is actuated. In the preferred embodiment, this actuation automatically sends the portion of image 400 under the window of interface 405 to transferer 325 for producing a tangible copy. The image portion is automatically sized and processed according to user options to transfer the image portion onto a laminar element. As discussed above, in some implementations, it is preferable to store the image portion in a memory/storage of transferer 325 for later transfer or editing. Interface 405 thus permits the user to quickly and simply transfer desired images onto media 325.

The second implementation for capturing a set of images is preferably adapted to use with a transferer 320 having multi-image capability. For example, animation pad printer 100 shown in FIG. 1, or the stamp product described in the incorporated patent applications are both suitable for multi-image transferer 320 used in the second implementation. In this implementation, a desired set or sequence of images are captured, and most preferably are sent to transferer 320 for transfer of the set of images. In some embodiments, this second implementation is advantageously used by computing system 305 or network computing system 315 to create a set of images that are useful independent of transferer 320.

For this implementation, image 400 is preferably a changing image resulting, such as a movie or animation presented by an appropriate process of one of the computing systems. Appropriate processes include AVI, MPEG, QUICKTIME players and the like. The image source may be local to computing system 305, network 315 or, in some implementations, stored in transferer 320. The image sequence may be rendered either on display 270 of computing system 305 or display 270 of transferer 320. Image sources may be analog or digital, and appropriate conversion as well known to render an image sequence on a display of a component of system 300 executing interface 405.

These processes typically provide the user with an ability to size the active region used to display the animation/image sequence. It is preferable in the preferred embodiment, due to the processing requirements, to set the animation player process to generate an image size as close to a one-to-one correspondence to reduce scaling requirements, but is some implementations it is not necessary. For example, actuating interface 405 presents the semi-transparent window, initially at a one-to-one scaling. The user positions the windows of interface 405 and the player active region and adjusts the player active region size to match.

In this implementation, there are more options for the user, some of which may be automated. For example, in capturing a set of images or image sequence to media 325, it is important to match a length of the relevant portion of the target image source to the length of the captured image set. The “length” is measurable using many different parameters, but a common measure of a source image sequence is the running time (seconds) or number of frames and frames/second (or equivalent). The maximum length of the captured image set is measured by either the amount of free storage available to receive the image set, or, in the case of direct transfer onto media 325, the number of laminar elements (e.g., pages) available in the prospective animation book for use. Currently, pads come packaged with 12, 20, 50 or 100 sheets. In a simple embodiment, interface 405 is provided (e.g., manually from the user or automatically from the player) with the length of the image sequence to be captured (which may be a portion of the overall image sequence) and the number of available animation pages in media 325.

For example, for a sixty second video, and eleven available sheets, interface 405 captures an image from the active region of the video player every six seconds (11−1/60) is one/six seconds. One is subtracted from the number of available pages to permit interface 405 to capture the initial image at time t=0. Interface 405 may estimate, count or receive a page count of the available elements.

More complicated capture options are possible. In some cases, interface 405 is able to pause the player or buffer captured images to permit a user to add another media 325. In these cases, the user sets a total number of available sheets across all available media 325, or for relatively limitless media 325 sources, the user may simply set a capture frequency and interface 405 pauses the player or buffers additional images when media is to be replaced in transferer 320. In some implementations, transferer 320 is able to print on both sides of the laminar elements 325 (or media 325 may be flipped over for transfer to another side of the laminar elements).

Another available option is for particular scenes or frames to be captured. In this case, interface 405 distributes the available sheets to capture the desired images and interpolates between and ratios timing between the image source and the capture process as measured by sheets. In some cases, interface 405 may interpolate or “morph” non-essential images to smooth the image sequence while capturing the desired images. In a simple implementation, desired images are identified at particular time intervals from a start. In other implementations, interface 405 is incorporated/integrated into an image player. In this case the presentation window, for capture, is preferably scaled to the appropriate size for capture. Many players include a “slider” control that is used to display selected frames of an image sequence, with the slider representing a first frame when in one extreme, a last frame in the other extreme, with intermediate frames mapped to in between slider positions. Interface 405 may be responsive to the slider control to record desired capture points, such as having a user create “capture points” along the slider, such as, for example, “double clicking” an interface element on the slider when it is appropriately positioned.

Sequenced images, as used herein, includes not only consecutive or sampled sub-sets of “animation frames” for “action” scenes, but also includes individual pages of multi-page documents or images. For example, PowerPoint presentations, word processing documents, spreadsheets, and other multi-page electronic documents may have individual pages transferred to individual elements of media 325.

Processing may also include capturing/building custom elements/scenes into the sequenced images. For example, an image of a child (or recognizable feature of the child—e.g., a face) is rendered into the appropriate format and added into an animation sequence. In this embodiment, various “stock” sequenced images are designed to have a custom avatar inserted to provide a sense that the child is interacting in the sequenced image. Examples of such stock sequenced images could be a walk/event with the child's favorite fictional/fantasy/sports/entertainment character, such as a birthday gathering of several of these characters celebrating with the child. The range of such “stock” sequences is virtually endless and limitless. Interface 405 of this implementation is adapted to gather appropriate content for insertion into ‘placeholders’ in the sequenced images.

In some cases, transferer 320 has security/rights management control to limit a number of products that may be produced from certain such sequences. The number of products that may be produced is controlled by a sequence configurator process of transferer 320. The configurator may include an audit/communications function to change the allowed number and to report a number of manufactured products for billing.

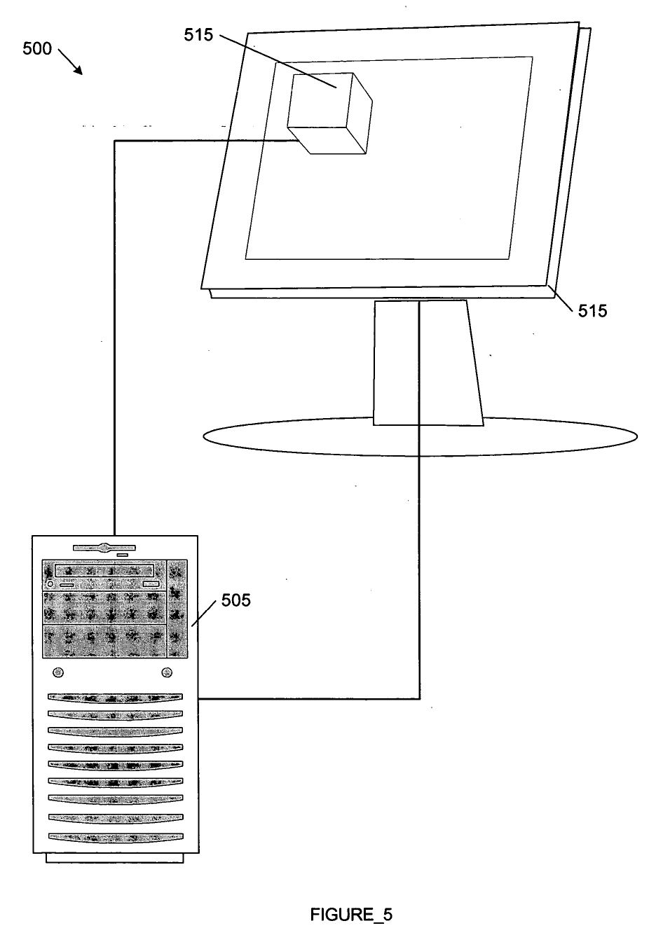

FIG. 5 is a schematic block diagram of an alternate preferred embodiment for an image capture/transfer system 500. System 500 includes an interactive pad transfer system 505 coupled to a computing system 510 having a display 515. Interactive system 505 is a special implementation of system 100 shown in FIG. 1, or any of the pad transfer systems shown in the incorporated patent applications for static or sequenced images. The special implementation is that system 505 interacts with display 515 so that system 510 is able to determine a particular portion of the image presented on display 515 that system 505 overlies. Using system 505 to control interface 405 discussed above provides system 500 with an ability for a user to simply proximate (e.g., touch) system 505 to a desired portion of the image on display 515 to capture/transfer (e.g., print) that desired portion. In one sense, system 505 is an image “cookie cutter” to identify/capture/transfer selected image portions. As discussed above, a user controls various attributes of the interface window, and that control may be incorporated into system 505 such as, for example, to control the window scaling between a cross-section of system 505 proximate display 515 and the size of the capture window on display 515. Capture of the desired portion may be manual or automatic. In an alternate preferred embodiment, system 505 is responsive to an interface element of system 510 (e.g., a stylus or wand) touching an image portion on display 515 and capturing/transferring the identified image.

There are many different solutions to detecting where system 505 is with respect to display 515. In one solution, display 515 is touch sensitive and system 505 includes a locator element to touch the display at a reference location to position interface 405, for example. In another implementation, system 505 includes a sensor that detects a relative location with respect to display 515, such as through detecting a special locating pattern (often undetectable to unaided human vision) presented by system 510 on display 515. Synchronizing the pattern using the sensor locates system 505 relative to an image portion presented on display 515.

Such an implementation has many useful applications, including quick capture/transfer of information from a kiosk at an airport, mall, museum, sporting venue, office lobby, retail outlet, tradeshow, or other location where people gather together. The kiosk presents a matrix (static or varying) of images (some of which the user is able to select) and a user operates system 505 to capture a desired image that has the desired information. System 505 produces a tangible copy of the user's benefit. The information may be gate arrival/departure information, contact information, directions, background information or virtually any other graphical/textual information useful/beneficial to the user/kiosk operator in the specific location of the kiosk. In some implementations, system 510 includes a standard protocol to permit a user to use a personal system 505 to synchronize with display 515 (or in some instances an image database) and capture/transfer desired graphical/textual information into a memory or onto an element of pad 120/media 325.

In the preferred embodiment, pad 120/media 325 is two or more similarly sized laminar elements co-bonded (by individual adhesive between the sheets or by an edge bonding (like perfect binding)). In some instances, like the 3M Printscape product, a dual-ply print medium is passed through a laser printer imaging path. This is not a pad. Laser printers are designed for a single element (and will accept multiple elements if they may be processed as a single sheet), while the present invention is designed to handle a print medium that includes multiple similarly sized sheets. The embodiments of the present invention are adaptable for pads having three to ten, or more similarly sized sheets. Generally, any number of transfer medium sheets, of any weight, may be processed using the present invention, and while present invention may still be functional to print on pads having one or two sheets, this is not the intended use. Media composition/weight is particularly important for animation pads to have the correct flipping and operational considerations. Paper of traditional pads of prior art Post-it® Notes are generally too thin/light-weight for preferable animation pad use, though they may be used in some implementations.

In some instances, it may be desirable to assemble the pad from individual laminar elements. For example, media (sheets or rolls of desired weight paper) may be prepared for processing using the present invention, with a pad assembled/manufactured at the time of image transfer, or afterwards. It is believed that manufacture of custom Post-it® Notes involves commercial printing off of rolls of paper, a die-cutting process, an adhesive applying process, and an assembly process, though details of the process are generally unavailable. In an alternate preferred embodiment, appropriately sized laminar elements (e.g., sheets of pad 120) are individually imaged and assembled. The assembly may be by exposing a pre-applied adhesive (semi-tacky or “permanent”) from the sheets and “stacking” the elements to form the pad. In some implementations, it is desirable to “bind” the individual sheets for advantageous animation pad use. For example, in addition to the “perfect binding” discussed above, in some cases the laminar elements are stacked and a spine-binding material is overlapped over a portion of one edge to “hingedly” couple the individual elements together.
The adhesive may be exposed by removing a protective overlayer (e.g., peeling a Mylar strip or melting/dissolving a coating, for example melting a “waxy” coating using heat from a fuser roll in the transfer engine.) In some cases, the image transfer engine may be adapted/synchronized to protect the adhesive (whether exposed or protected). A region on the fuser roll or other transfer engine element is adapted to protect/apply the adhesive as it moves through the image transfer process. The particular type of protection/application dependent upon the image transfer engine.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. An image capture method, the method comprising:
activating an interface element for a computing system having a control logic and a display to position a capture interface element over a portion of an image presented on said display by said computing system; and
capturing said portion to an image transfer system external to said computing system using said computing system.

2. A computer program product comprising a computer readable medium carrying program instructions for capturing an image when executed using a computing system, the executed program instructions executing a method, the method comprising:
activating an interface element for the computing system having a control logic and a display to position a capture interface element over a portion of an image presented on said display by the computing system; and
capturing said portion to an image transfer system external to the computing system using the computing system.

3. An information distribution system, comprising:
a kiosk having a display presenting one or more images from a computing system; and
an interactive pad transfer system, coupled to said computing system, to capture one or more of said one or more images by proximating an element of said interactive pad transfer system to a portion of said display presenting said one or more images to be captured.
